(19) United States
(12) Patent Application Publication
(10) Pub. No.: US 2012/0201989 A1
(43) Pub. Date: Aug. 9, 2012

(54) RESIN MOLDED PRODUCT

(75) Inventors: Nobuhiro Minato, Tokyo (JP); Naruto Nogawa, Tokyo (JP); Masaharu Endou, Hagagun, Tochigi (JP)

(73) Assignee: HONDA MOTOR CO., LTD., Tokyo (JP)

(21) Appl. No.: 13/501,775

(22) PCT Filed: Oct. 7, 2010
(86) PCT No.: PCT/JP2010/067651

§ 371 Date: Apr. 13, 2012

(30) Foreign Application Priority Data
Oct. 15, 2009 (JP) 2009-238243

(51) Int. Cl. B32B 1/02; B60R 19/24

(52) U.S. Cl. 428/36.92

(57) ABSTRACT

Provided is a resin molded product in which a lid body is prevented from being erroneously mounted. An upper bumper (1) is molded from synthetic resin such that a product body (1h) thereof has a predetermined thickness (T). The product body (1h) is provided with a recessed portion (1a) that can accommodate a head portion (5a) of a bolt (5). The upper bumper (1) is provided with a cap (1b) that covers an opening (11k) of the recessed portion (1a). The upper bumper (1) is provided with a band-shaped hinge body (1c) that connects the cap (1b) and the product body (1h) and has a bendable thin thickness (t). The product body (1h), the cap (1b), and the hinge body (1c) are integrally molded while the hinge body (1c) is developed.

### TECHNICAL FIELD

The present invention relates to a resin molded product. More specifically, it relates to the structure of a resin molded product applied to the bumpers, panels and the like of automobiles.

### BACKGROUND ART

Generally, when fixing a bumper molded from synthetic resin with a bolt to a vehicle body, the head of the bolt is accommodated in a recessed portion formed in the bumper. Then, it is configured so that the recessed portion is covered by covering the opening (bolt hole) of the bolt-mounted part with a cap molded from synthetic resin so that the head of the bolt is not exposed to outside.

In this case, if the bumper and cap are painted individually, there will be a flaw in that the aesthetics are harmed by a slight color difference arising between the outer surface of the bumper and the outer surface of the cap.

In order to resolve this flaw, a method of painting bumpers has been developed that prevents the occurrence of a color difference by simultaneously painting the bumper and the cap (e.g., refer to Patent Document 1).

The method of painting bumpers according to Patent Document 1 provides a provisional support hole in a portion of the bumper not requiring painting (wheel arch covered by wheel arch molding), and paints the bumper and cap simultaneously in a state provisionally supporting the cap, which will hide the head of the bolt fixing the bumper, at the provisional support hole.

The method for painting bumpers according to the Patent Document 1 thereby makes it possible to prevent the occurrence of a color difference by simultaneously painting the bumper and cap. In addition, even if a part of the wheel arch of the bumper is obstructed and is in an unpainted state, the method for painting bumpers according to Patent Document 1 eliminates obstacles since this unpainted portion will ultimately be covered by the wheel arch molding and become unviewable.

Patent Document 1: Japanese Unexamined Patent Application, Publication No. 2006-314928

### DISCLOSURE OF THE INVENTION

### Problems to be Solved by the Invention

However, in the method for painting bumpers according to Patent Document 1, the bumper and cap are produced (molded) individually; therefore, the man-hours for management increase from increases in preventative measures for assembly mistakes and in the parts count.

Therefore, a reduction in the man-hours for management of the cap has been demanded upon installing the cap to the bolt hole of the bumper molded from synthetic resin. Furthermore, a resin molded product has been demanded that prevents the occurrence of color differences by painting bumpers and caps simultaneously. Additionally, the above matters may be called the problem of the present invention.

The present invention has been made taking such problems into account, and has an object of providing a resin molded product that reduces the man-hours for management of the lid covering an opening provided in a resin molded product such as a bumper, and prevents the occurrence of color differences between the resin molded product and the lid.

### Means for Solving the Problems

In order to achieve the above-mentioned object, the present inventors have found that the above-mentioned problems can be solved by molding the resin molded product and lid integrally connected with a thin hinge, and painting in a state in which the lid is provisionally fixed to the resin molded product, based on which inventing of the following such novel resin molded product was arrived at.

According to a first aspect of a resin molded product of the present invention, a product main body (e.g., the production main body 1h) molded in resin, a lid (e.g., the cap 1b) attached to the product main body, and a bendable hinge body (e.g., the hinge body 1c) connecting the lid and the product main body are integrally molded, and the lid is provided to be installable to the product main body in a state bending the hinge body.

The resin molded product according to the first aspect of the present invention can prevent a lid having a color difference from being mistakenly mounted to a main body, since the main body that is the resin molded product and the lid are integrally molded to be connected by a thin hinge body.

In addition, since the lid covers the opening of the recessed portion in the state in which the hinge body is accommodated in the recessed portion, the resin molded product according to the first aspect of the present invention has a merit in that the aesthetics will not be harmed. It should be noted that, in the present disclosure, “bend” includes the form of “fold (making smaller by overlapping several times)”.

According to a second aspect of the resin molded product of the present invention, in the resin molded product as described in the first aspect, the product main body and the lid are molded to have an inner surface (e.g., the inner surface 11h) on an opposite side to an outer surface (e.g., the outer surface 10h) thereof rougher than the outer surface.

The resin molded product according to the second aspect of the present invention has inner surfaces of the product main body and lid that are roughened, and thus the inner walls of one of the pair of molds used in injection molding can be made rougher than the inner walls of the other thereof, and can reduced the expensive of the mirror surface finishing of the inner walls.

According to a third aspect of the resin molded product of the present invention, in the resin molded product as described in the first or second aspect, the hinge body is bent to be stored in the product main body, and then the lid is provisionally fixed to the product main body providing a gap therebetween, and painting is conducted in a state provisionally fixed.

The resin molded product according to the third aspect of the present invention is painted on an outer surface together with the product main body in a state in which the periphery of the lid is provisionally fixed with the product main body to be separated; therefore, it is possible to completely paint the periphery of the lid and the step of the opening of the recessed portion.

According to a fourth aspect of the resin molded product of the present invention, in the resin molded product as described in the first or second aspect, an elastic force is generated by bending the hinge body, and the lid is fitted and attached to the product main body in this state.

According to a fifth aspect of the resin molded product of the present invention, in the resin molded product as described in the first or fourth aspect, at least two bending portions are provided in the hinge body.

According to a sixth aspect of the resin molded product of the present invention, in the resin molded product as described in the first, fourth or fifth aspect, the hinge body provided to be linked at a leading end of the lid is a hat-brim shape.

According to a seventh aspect of the resin molded product of the present invention, in the resin molded product as described in any one of the first to sixth aspects, a multi-step shaped positioning part is formed at a locking portion that provisionally retains the lid to the product main body.

According to an eighth aspect of the resin molded product of the present invention, in the resin molded product as described in the seventh aspect, a gap is maintained between the product main body and a lateral part and an underside part of the lid when provisionally retaining the lid to the product main body.

### Effects of the Invention

The resin molded product according to the present invention can prevent a lid having a color difference from being mistakenly mounted to a main body, since the main body that is the resin molded product and the lid are integrally molded to be connected by a thin hinge. The resin molded product according to the present invention can reduce the man-hours for management of the lid to cover an opening provided in a resin molded product such as a bumper.

### BRIEF DESCRIPTION OF THE DRAWINGS

FIG. 1 is a perspective view showing a configuration of a rear bumper, which is a resin molded product according to an embodiment of the present invention, viewing a state installed to a vehicle from a rear-left side;

FIG. 2 is a front view of the rear bumper according to the embodiment;

FIG. 3 is an exploded perspective view viewing the rear bumper according to the embodiment from inside thereof, illustrating by magnifying a main part;

FIG. 4 is partially enlarged view of the rear bumper according to the embodiment, with FIG. 4(A) being a plan view of a recessed portion (bolt hole) molded in the rear bumper, FIG. 4(B) being a front view of FIG. 4(A), and FIG. 4(C) being a left-side view of FIG. 4(A);

FIG. 5 is an exploded perspective view of a recessed portion (bolt hole) molded in the rear bumper according to the embodiment, and is a state diagram before closing the recessed portion with the lid (cap);

FIG. 6 is a perspective view of the recessed portion (bolt hole) molded in the rear bumper according to the embodiment, and is a state diagram of painting the rear bumper; and

FIG. 7 is a partial sectional view of the rear bumper according to the embodiment, and is a state diagram of the rear bumper fixed to the vehicle body with a bolt.

### EXPLANATION OF REFERENCE NUMERALS

1 upper bumper (resin molded product)

1b cap (lid)

1c hinge body

1h product main body

### PREFERRED MODE FOR CARRYING OUT THE INVENTION

Hereinafter, a mode for carrying out the present invention will be explained while referring to the drawings.

First, the configuration of a resin molded product according to an embodiment of the present invention will be explained. It should be noted that the resin molded product according to the embodiment of the present invention will be explained hereinafter as a product applied to the rear bumper of an automobile.

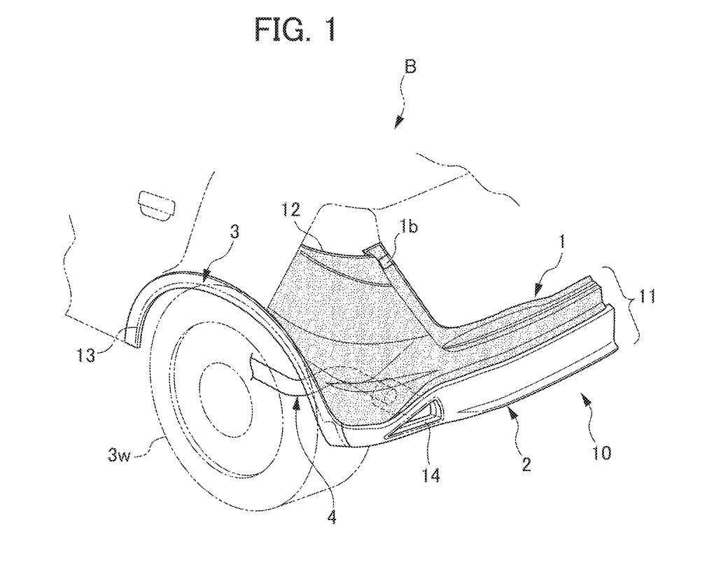

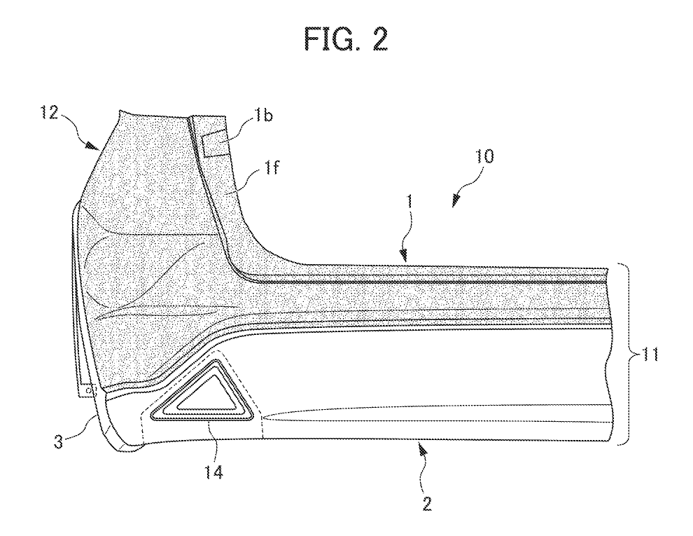

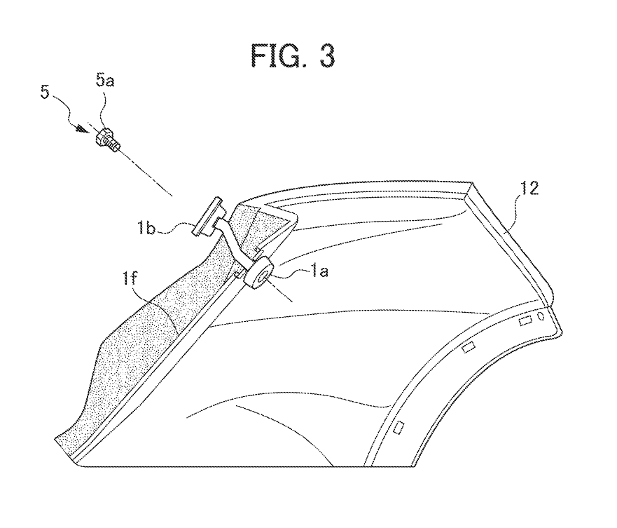

FIG. 1 is a perspective view showing the configuration of the rear bumper according to the embodiment of the present invention, viewing a state installed to a vehicle from a rear-left side. FIG. 2 is a front view of the rear bumper according to the embodiment. FIG. 3 is an exploded perspective view viewing the rear bumper according to the embodiment from inside thereof, illustrating by magnifying a main part.

Referring to FIG. 1 or FIG. 2, a rear bumper 10 according to the embodiment is configured by a painted upper bumper 1 and an unpainted lower bumper 2. The rear bumper 10 has a middle part 11 and a pair of lateral parts 12, 12. The middle part 11 extends in a left-right direction along the rear of a vehicle body (body) B. In addition, the pair of lateral parts 12, 12 extend forward of the vehicle body B from the left and right ends of the middle part 11. It should be noted that an illustration of the right-side lateral part 12 is omitted from FIGS. 1 to 3.

Referring to FIG. 1, a wheel arch 13 is formed by cutting out a portion of the vehicle body B in an arc shape so as to surround a rear wheel 3w. A wheel arch molding 3 covers the wheel arch 13. Then, a rear part of the wheel arch molding 3 joins with the lateral part 12 of the rear bumper 10. In addition, an exhaust finisher 14 is provided at the left side of the lower bumper 2. The exhaust finisher 14 decorates the outlet of an exhaust pipe 4.

Referring to FIGS. 1 to 3, the lateral parts 12, 12 at both wings of the upper bumper 1 are respectively fixed to the vehicle body B with two bolts 5, 5. A recessed portion (bolt hole) 1a of a circular truncated cone shape projecting towards the inside is provided to a flange 1f provided in the upper bumper 1. Then, in order to conceal a head 5a of the bolt 5 accommodated in the recessed portion 1a, a cap 1b that is a lid covers the opening of the recessed portion 1a.

Next, the configurations of the cap 1b and the recessed portion 1a provided in the rear bumper 10 according to the embodiment of the present invention will be explained.

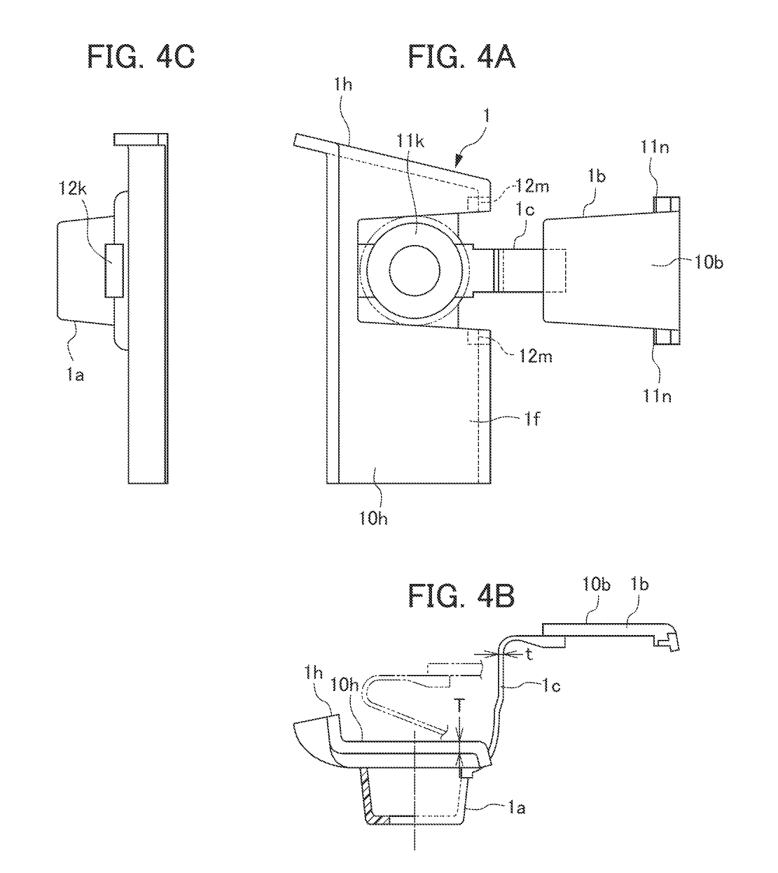

FIG. 4 is partially enlarged view of the rear bumper according to the embodiment, with FIG. 4(A) being a plan view of the recessed portion (bolt hole) molded in the rear bumper, FIG. 4(B) being a front view of FIG. 4(A), and FIG. 4(C) being a left-side view of FIG. 4(A).

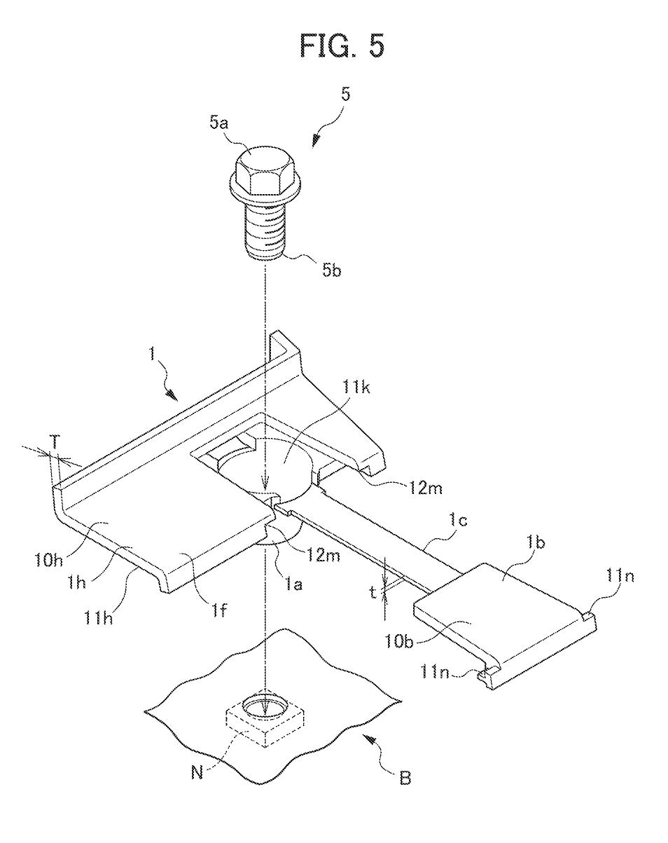

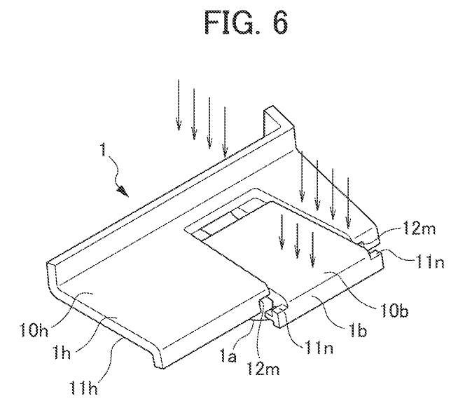

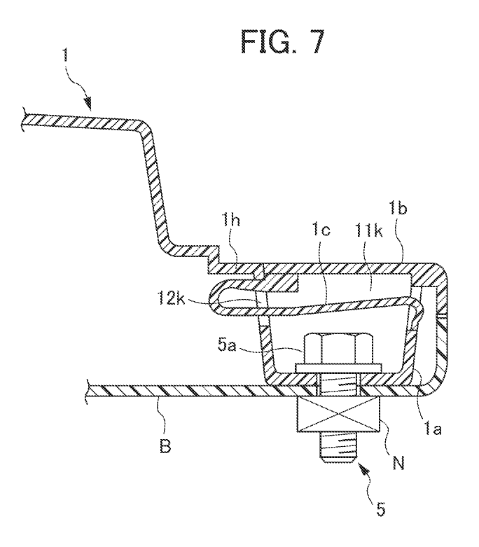

In addition, FIG. 5 is an exploded perspective view of the recessed portion (bolt hole) molded in the rear bumper according to the embodiment, and is a state diagram before closing the recessed portion with the lid (cap). FIG. 6 is a perspective view of the recessed portion (bolt hole) molded in the rear bumper according to the embodiment, and is a state diagram of painting the rear bumper. FIG. 7 is a partial sectional view of the rear bumper according to the embodiment, and is a state diagram of the rear bumper fixed to the vehicle body with a bolt.

Referring to FIGS. 4 to 7, the upper bumper 1 is molded from a synthetic resin such as polypropylene (PP) so that a product main body 1h thereof has a predetermined thickness T. The product main body 1h includes a recessed portion 1a that can accommodate the head 5a of the bolt 5.

In addition, referring to FIG. 4 or 5, the product main body 1h includes the cap 1b that is a lid to cover an opening 11k of the recessed portion 1a. Furthermore, the product main body 1h includes a bendable band-shaped hinge body 1c of a thickness t that connects the cap 1b and product main body 1h. Then, the product main body 1h, cap 1b and hinge body 1c are integrally molded in a state in which the hinge body 1c is expanded.

Referring to FIG. 7, the cap 1b covers the opening 11k of the recessed portion 1a in a state in which the hinge body 1c is bent and accommodated in the recessed portion 1a. Therefore, since the cap 1b covers the opening 11k of the recessed portion 1a in the state in which the hinge body 1c is accommodated in the recessed portion 1a, there is a merit in that the aesthetics will not be harmed.

It should be noted that, when referring to FIG. 7, the curved portion of the hinge body 1c projects from the opening 12k formed at the outer periphery of the recessed portion 1a. However, the hinge body 1c will not harm the aesthetics due to being shielded in the product main body 1h.

Referring to FIG. 5 or 7, a nut N is welded to the vehicle body B. A thread portion 5b of the bolt 5 penetrated through a bottom wall of the recessed portion 1a and the vehicle body B threads with the nut N to be fastened. It is thereby possible to fix the upper bumper 1 to the vehicle body B (refer to FIG. 1).

Next, functions will be explained while complementing the configurations of the cap 1b and recessed portion 1a provided to the rear bumper 10 according to the embodiment of the present invention.

Referring to FIGS. 4 to 7, the upper bumper (resin molded product) 1 according to the embodiment of the present invention can prevent a cap 1b having a color difference from being mistakenly mounted to the product main body 1h, since the product main body 1h and the cap 1b serving as a lid are integrally molded to be connected by the thin hinge body 1c.

Referring to FIGS. 4 and 5, the periphery of the opening 11k of the recessed portion 1a is a stepped-surface that is lower than an outer surface 10h of the product main body 1h. Then, by sliding the cap 1b to this stepped surface to fit with the opening 11k (to block the opening 11k), the outer surface 10h of the product main body 1h and an outer surface 10b of the cap 1b can be made flush, thereby excelling in aesthetics.

Referring to FIG. 6, the cap 1b is painted on the outer surface together with the product main body 1h in a state in which the periphery thereof (thickness surface) is provisionally fixed with the product main body 1h to be separated. It should be noted that the plurality of arrows illustrated in FIG. 6 indicate the paint painted on the outer surface of the upper bumper 1.

The rear bumper 10 according to the embodiment of the present invention is painted on an outer surface together with the product main body 1h in a state in which the periphery of the cap 1b is provisionally fixed with the product main body 1h to be separated; therefore, it is possible to completely paint the periphery of the cap 1b and the step of the opening 11k of the recessed portion 1a.

In addition, referring to FIGS. 4 to 6, in order to secure a state in which the periphery of the cap 1b is provisionally fixed with the product main body 1h to be separated, a pair of stoppers 11n, 11n that project is provided at both wings of the cap 1b, and a pair of steps 12m, 12m abutted by the pair of stoppers 11n, 11n is provided at an inner surface 11h of the product main body 1h on an opposite side to the outer surface 10h.

It should be noted that FIG. 6 shows a state immediately prior to the cap 1b being provisionally fixed to the product main body 1h so that the relationship between the pair of stoppers 11n, 11n and the pair of steps 12m, 12m is understood. Upon provisionally retaining the cap 1b to the product main body 1h, the position of the cap 1b is decided by these steps 12m, 12m.

In addition, referring to FIG. 7, in a state in which the hinge body 1c is bent, the force (elastic force) biasing to the inner surface 11h of the product main body 1h acts on the pair of stoppers 11n, 11n; therefore, the provisionally fixed state can be maintained. Furthermore, the cap 1b can be fitted to the product main body 1h without a gap by sliding the cap 1b to cross over the pair of steps 12m, 12m.

In addition, referring to FIGS. 4 to 7, in the product main body 1h, cap 1b and hinge body 1c, inner surfaces on opposite sides to the outer surfaces of these are molded to be rougher than these outer surfaces. This is because, for these inner surfaces, it is difficult to view when the vehicle body is completed, and there is no hindrance to the appearance.

In this regard, the upper bumper 1 is molded by injecting molten resin to the inside of a pair of opposing molds (not illustrated). As a result, among of this pair of molds, the inner walls of one mold corresponding to the inner surface 11h of the upper bumper 1 can be made rougher than the inner walls of the other mold corresponding to the outer surface 10h of the upper bumper 1.

Generally, in the aforementioned pair of molds for plastic molding, the inner walls thereof are machined to a mirror finish; therefore, the production cost is expensive. In contrast, the molds for molding the upper bumper 1 according to the embodiment of the present invention can be made with the inner walls of one mold rougher than the inner walls of the other mold; therefore, there is an effect of being able to decrease the production cost.

It should be noted that the resin molded product and painting method according to the present invention are not to be limited to the embodiment. The method of integrally molding the resin molded product and lid to be connected by a thin bendable hinge, as well as painting in a state provisionally fixing the lid to the resin molded production are not limited to a bumper installed to a vehicle body. Application in every field can be considered.

1. A resin molded product, wherein a product main body molded in resin, a lid attached to the product main body, and a bendable hinge body connecting the lid and the product main body are integrally molded, and
wherein the lid is provided to be installable to the product main body in a state bending the hinge body.

2. The resin molded product according to claim 1, wherein the product main body and the lid are molded to have an inner surface on an opposite side to an outer surface thereof rougher than the outer surface.

3. The resin molded product according to claim 1, wherein the hinge body is bent to be stored in the product main body, and then the lid is provisionally fixed to the product main body providing a gap therebetween, and painting is conducted in a state provisionally fixed.

4. The resin molded product according to claim 1, wherein an elastic force is generated by bending the hinge body, and the lid is fitted and attached to the product main body in this state.

5. The resin molded product according to claim 1, wherein at least two bending portions are provided in the hinge body.

6. The resin molded product according to claim 1, wherein the hinge body provided to be linked at a leading end of the lid is a hat-brim shape.

7. The resin molded product according to claim 1, wherein a multi-step shaped positioning part is formed at a locking portion that provisionally retains the lid to the product main body.

8. The resin molded product according to claim 7, wherein a gap is maintained between the product main body and a lateral part and an underside part of the lid when provisionally retaining the lid to the product main body.
